(19) United States
(12) Patent Application Publication
(10) Pub. No.: US 2018/0294455 A1
(43) Pub. Date: Oct. 11, 2018

(54) POROUS FILM AND ELECTRICITY STORAGE DEVICE

(71) Applicant: UBE INDUSTRIES, LTD., Ube-shi (JP)

(72) Inventors: Ryo SAKIMOTO, Sodegaura-shi (JP); Akihiro MATSUBAYASHI, Chiba-shi (JP); Shusei OHYA, Chiba-shi (JP); Taiga ADACHI, Osaka (JP)

(73) Assignee: UBE INDUSTRIES, LTD., Ube-shi (JP)

(21) Appl. No.: 15/766,328

(22) PCT Filed: Oct. 31, 2016
(86) PCT No.: PCT/JP2016/082259

§ 371 Date: Apr. 5, 2018

(30) Foreign Application Priority Data
Oct. 30, 2015 (JP) 2015-214929

(51) Int. Cl. H01M 2/16; B32B 27/32; H01G 11/52; H01G 11/06; H01G 11/32; H01G 11/60; H01M 10/0525; H01M 10/0569; H01M 4/583; H01M 4/505; H01M 4/525; H01M 4/62; H01M 4/66; H01M 10/0587

(52) U.S. Cl. CPC H01M 2/162; H01M 2004/027; H01G 11/52; H01G 11/06; H01G 11/32; H01G 11/60; H01M 10/0525; H01M 10/0569; H01M 4/583; H01M 4/505; H01M 4/525; H01M 4/623; H01M 4/661; H01M 10/0587; B32B 27/32

(57) ABSTRACT

A porous film including a micro porous film in which a fibril diameter arranged in a direction perpendicular to an MD direction is 50 nm or more and 500 nm or less, a pore diameter is 50 nm or more and 200 nm or less, and a surface opening ratio is 5% or more and 40% or less. In the porous film, the micro porous film may include either one or both of a polyethylene resin and a polypropylene resin.

### TECHNICAL FIELD

The present invention relates to a porous film used as a separator for a power-storage device (electricity storage device), and a power-storage device in which the porous film is used.

The present application claims priority on Japanese Patent Application No. 2015-214929 filed on Oct. 30, 2015, the content of which is incorporated herein by reference.

### BACKGROUND ART

In a power-storage device such as a lithium-ion secondary battery, a lithium-ion capacitor and the like, a separator consisting of a polyolefin micro porous film is interposed between positive and negative electrodes in order to prevent a short circuit between both the positive and negative electrodes. In recent years, power-storage devices with high energy density, high electromotive force, and low self-discharge, particularly a lithium-ion secondary battery, a lithium-ion capacitor, and the like have been developed and put to practical use.

As the material of the negative electrode of a lithium-ion secondary battery, for example, metal lithium (metallic lithium), an alloy of lithium and another metal, an organic material having an ability to adsorb lithium ions or an ability to occlude lithium ions through intercalation, such as carbon, graphite, and the like, a conductive polymer material doped with lithium ions, and the like have been known.

As the material of the positive electrode, for example, graphite fluoride represented by (CFₓ)ₙ, metal oxide such as MnO₂, V₂O₅, CuO, Ag₂CrO₄, TiO₂, and the like, sulfide, and chloride have been known.

As a non-aqueous electrolytic solution, a solution obtained by dissolving an electrolyte such as LiPF₆, LiBF₄, LiCIO₄, LiCF₃SO₃ or the like in an organic solvent such as ethylene carbonate (EC), propylene carbonate (PC), diethyl carbonate (DEC), dimethyl carbonate (DMC), γ-butyrolactone, acetonitrile, 1,2-dimethoxyethane, tetrahydrofuran, or the like has been used.

Lithium has particularly strong reactivity; and therefore, in the case where an abnormal current flows due to an external short circuit, an erroneous connection, or the like, there is concern that the battery temperature may greatly rise, and thermal damage to a device with the battery assembled therein may be caused. In order to avoid such a risk, a single-layer or laminated polyolefin micro porous film has been suggested as a separator for a power-storage device such as a lithium-ion secondary battery, lithium-ion capacitor, and the like.

For example, in Patent Document 1, a method of producing a micro porous polyolefin porous material is disclosed, and in the method, an inorganic fine powder, an organic liquid, and a polyolefin resin are mixed, the mixture is subjected to melting and forming, and the organic liquid and the inorganic powder are extracted from the formed product.

For example, in Patent Document 2, a method of producing a release cell type micro porous polymer film is disclosed, and in the method, a non-porous elastic film having a degree of crystallinity of 20% or more and an elastic recovery ratio of at least 40% which is a recovery ratio recovered from a strain of 50% at 25° C. is subjected to low-temperature stretching until a porous surface region perpendicular to an extension direction is formed to obtain a low-temperature-stretched film, the formed low-temperature-stretched film is subjected to high-temperature stretching until pores stretched parallel to the stretching direction are formed to obtain a micro porous film, and the micro porous film is heated while a tension force is applied.

In Patent Document 3, a separator for a battery is disclosed, and the separator consists of a multi-layer porous film having a resin porous film containing a thermoplastic resin as a main component and a heat-resistant porous layer containing heat-resistant particles as a main component and a resin binder.

In recent years, as the power-storage devices become widely used, there has been progress in reducing costs, increasing capacity, and increasing rate of the power-storage device. Even regarding a cellulosic film used in a power-storage device in which an aqueous electrolyte is used, a number of fields in which the cellulosic film can be applied is increasing depending on the use of the power-storage device and the configuration of members such as electrode materials and the like.

### PRIOR ART DOCUMENTS

### Patent Documents

Patent Document 1: Japanese Unexamined Patent Application, First Publication No. S55-131028

Patent Document 2: Japanese Examined Patent Application, Second Publication No. S55-32531

Patent Document 3: Japanese Patent No. 5259721

### DISCLOSURE OF THE INVENTION

### Problems to be Solved by the Invention

For a power-storage device provided with a separator consisting of the micro porous film of the related art, a decrease in resistance and the suppression of the generation of dendrites caused by charging and discharging were required.

The present invention has been made taking the foregoing circumstances into consideration, and an object thereof is to provide a porous film which enables a power-storage device to have a low resistance and more favorable dendrite resistance (anti-dendrite properties) by using the porous film as a separator of the power-storage device.

Another object of the present invention is to provide a power-storage device which is provided with a separator including the porous film and has low resistance and favorable dendrite resistance.

### Means for Solving the Problem

The present invention is the following (1) to (12).

(1) A porous film including: a micro porous film in which a fibril diameter arranged in a direction perpendicular to an MD direction is 50 nm or more and 500 nm or less, a pore diameter is 50 nm or more and 200 nm or less, and a surface opening ratio is 5% or more and 40% or less.

(2) The porous film according to (1), in which the micro porous film includes either one or both of a polyethylene resin and a polypropylene resin.

(3) The porous film according to (1) or (2), in which a compressive elastic modulus of the micro porous film in a film thickness direction is 95 MPa or more and 150 MPa or less.

(4) The porous film according to any one of (1) to (3), in which the micro porous film has a film thickness of 7 μm or more and 40 μm or less and an air permeability of 80 sec/100 cc or more and 800 sec/100 cc or less.

(5) The porous film according to any one of (1) to (4), further including: a high porosity layer which is provided on one surface or both surfaces of the micro porous film and contains an organic binder.

(6) The porous film according to (5), in which the organic binder is one type or a mixture of two or more types selected from the group consisting of an acrylic resin, styrene butadiene rubber, a polyolefin-based resin, polytetrafluoroethylene, polyvinylidene fluoride, polyacrylonitrile, polymethyl methacrylate, and polyacrylic acid.

(7) The porous film according to (5) or (6), in which the high porosity layer contains organic particles which consist of one type or a mixture of two or more types selected from the group consisting of a polyethylene-based resin, a polypropylene-based resin, an acrylic resin, and a polystyrene-based resin, and the organic particles have a spherical shape, an elliptical shape, or a flat shape, and have a mode particle diameter of 0.1 μm or more and 5.0 μm or less.

(8) The porous film according to any one of (5) to (7), in which the high porosity layer contains inorganic particles which consist of one type or a mixture of two or more types selected from the group consisting of alumina, alumina hydrate, zirconia, magnesia, aluminum hydroxide, magnesium hydroxide, magnesium carbonate, boehmite, and silica.

(9) A power-storage device including: a positive electrode; a negative electrode; a separator interposed between the positive electrode and the negative electrode; and a non-aqueous electrolytic solution with which the separator is impregnated, in which the separator includes the porous film according to any one of (1) to (8).

(10) A power-storage device including: a positive electrode; a negative electrode; a separator interposed between the positive electrode and the negative electrode; and a non-aqueous electrolytic solution with which the separator is impregnated, in which the separator includes the porous film according to any one of (5) to (8), and the high porosity layer of the porous film is disposed in contact with a surface of the negative electrode.

(11) The power-storage device according to (9), in which the separator includes: a first porous film which is the porous film including the micro porous film; and a second porous film which is the porous film including the high porosity layer on one surface of the micro porous film, and the high porosity layer of the second porous film is disposed in contact with the first porous film.

### EFFECTS OF THE INVENTION

The porous film of the present invention includes the micro porous film in which the fibril diameter arranged in the direction perpendicular to the MD direction, the pore diameter, and the surface opening ratio are in the predetermined ranges. Therefore, the power-storage device including the porous film of the present invention as the separator has low resistance and favorable dendrite resistance.

### Embodiments for Carrying Out the Invention

In a power-storage device for automotive applications, there has been progress in increasing safety, capacity, and rate. A separator for such a power-storage device cannot meet the market demand for battery characteristics by being superior to only specific characteristics. Therefore, in the separator for a power-storage device, it is required that structural parameters contributing to charging and discharging characteristics are appropriately adjusted and the balance between physical properties for the separator is good.

As a result of trial and error, the inventors discovered that in a porous film used as a separator for a power-storage device, the optimum structural parameters contributing to charging and discharging characteristics are the ranges of a fibril diameter arranged in a direction perpendicular to an MD direction, a pore diameter, and a surface opening ratio. Furthermore, the inventors discovered a porous film capable of maintaining safety and having excellent balance between characteristics in a case of being used as a separator.

In a porous film of an embodiment, structural parameters that contribute to charging and discharging characteristics in a case of being used as a separator for a power-storage device are adjusted to predetermined ranges, safety can be maintained, and the balance between characteristics for a separator is excellent. By using the porous film of the embodiment as the separator of a power-storage device, the resistance of the power-storage device can be decreased.

The present invention will be described below as an example, but the features of the present invention are not limited to the following matters.

The porous film of the embodiment has a micro porous film in which the fibril diameter arranged in a direction perpendicular to an MD direction is 50 nm or more and 500 nm or less, the pore diameter is 50 nm or more and 200 nm or less, and the surface opening ratio is 5% or more and 40% or less.

In the micro porous film of the porous film of the embodiment, the fibril diameter arranged in the direction perpendicular to the MD direction is 50 nm or more, more preferably 80 nm or more, and most preferably 100 nm or more. The upper limit thereof is 500 nm or less, more preferably 450 nm or less, and most preferably 400 nm or less.

In the case where the diameter of the fibrils of the micro porous film is too small, strength as a separator cannot be secured, which is not preferable. In the case where the diameter of the fibrils is too large, when the porous film is used as the separator of a power-storage device, fibrils of the micro porous film themselves inhibit ionic conduction in the power-storage device and increase the resistance of the power-storage device, which is not preferable.

Furthermore, the pore diameter of the micro porous film is 50 nm or more, more preferably 60 nm or more, and most preferably 80 nm or more. The upper limit thereof is 200 nm or less, more preferably 180 nm or less, and most preferably 150 nm or less.

In the case where the pore diameter of the micro porous film is too small, when the porous film is used as the separator of the power-storage device, ionic conduction is inhibited and the resistance of the power-storage device is increased, which is not preferable. On the other hand, in the case where the pore diameter is too large, the pore diameter distribution widens, the ion conductivity becomes uneven at portions having a large pore diameter and portions having a small pore diameter, and this causes deterioration of the power-storage device or favorable dendrite resistance cannot be obtained, which is not preferable.

Furthermore, the surface opening ratio of the micro porous film is 5% or more, more preferably 8% or more, and most preferably 9% or more. The upper limit thereof is 40% or less, more preferably 35% or less, and most preferably 31% or less. In the case where the surface opening ratio of the micro porous film is too small, this acts as the resistance of the power-storage device, which is not preferable. In the case where the surface opening ratio is too large, not only is the strength of the separator deteriorated, but also the surface roughness is increased, and the cycle characteristics or input and output characteristics of the power-storage device are impaired, which is not preferable. In addition, in the case where the surface porosity (surface opening ratio) is too large, it is considered that the risk of passing foreign matter and the like increases.

As the resin material forming the micro porous film, for example, a single type or two or more types of a polyethylene resin, a polypropylene resin, or resin material containing these resins as a main component may be used. It is preferable that the micro porous film includes (or consists of) either one or both of the polyethylene resin and the polypropylene resin.

The micro porous film including the polyethylene resin and/or the polypropylene resin has a proven record (track record) as a separator for a power-storage device, and by using the micro porous film including such a resin material as a separator, a power-storage device which has an appropriate shutdown temperature and is excellent in terms of low cost and stability can be obtained.

The compressive elastic modulus in a film thickness direction of the micro porous film is preferably 95 MPa or more, more preferably 100 MPa or more, even more preferably 103 MPa or more, and most preferably 105 MPa or more. The upper limit thereof is preferably 150 MPa or less, more preferably 148 MPa or less, even more preferably 145 MPa or less, and most preferably 140 MPa or less.

In the case where the compressive elastic modulus in the film thickness direction is low, when the micro porous film is used as the separator of the power-storage device for automobiles, the separator is crushed in a process of compressing the power-storage device at a high pressure, and desired characteristics cannot be obtained, which is not preferable. In order to obtain a separator which is less likely to be crushed, the higher the compressive elastic modulus of the micro porous film is, the more preferable it is. On the other hand, in the case where the compressive elastic modulus exceeds 150 MPa, the compressive elastic modulus is not suitable for the separator for a power-storage device. Therefore, the compressive elastic modulus is preferably 150 MPa or less.

By using the porous film of the embodiment as the separator of the power-storage device, a short circuit between both electrodes in the power-storage device can be prevented, and it is possible to maintain the voltage of the power-storage device. Furthermore, in the power-storage device in which the porous film of the embodiment is used as the separator, when the internal temperature rises to a predetermined temperature or more due to an abnormal current or the like, pores of the micro porous film that configures the porous film are blocked and become closed. As a result, it becomes difficult for ions to flow between both the electrodes; and thereby, the electrical resistance increases. Accordingly, the function of the power-storage device is stopped, and a danger of ignition or the like due to an excessive temperature rise is prevented; and thereby safety is secured. The function of preventing a danger of ignition or the like due to an excessive temperature rise in the power-storage device is extremely important for a separator and is generally called as pore closing or shutdown (hereinafter, referred to as SD).

In the case where a pore closing starting temperature of the micro porous film that configures the porous film used as the separator is too low, the flow of ions is impeded when the temperature slightly rise in the power-storage device, which results in a problem in practical use. Contrary to this, in the case where the pore closing starting temperature is too high, there is a risk that the flow of ions will not be impeded until ignition or the like occurs in the power-storage device, which results in a safety problem.

The pore closing starting temperature of the micro porous film that configures the porous film is preferably 110° C. to 160° C., and preferably 120° C. to 150° C.

In addition, when the temperature in the power-storage device rises above an upper limit temperature of maintaining pore closing of the micro porous film that configures the porous film used as the separator, the separator may be melted and broken. In this case, the movement of ions in the power-storage device is resumed, and the temperature further rises. For this reason, it is preferable that the separator for the power-storage device has a suitable pore closing starting temperature, a high upper limit temperature of maintaining pore closing at which pore closing can be maintained, and a wide temperature range in which pore closing can be maintained.

The film thickness of the micro porous film is preferably 7 μm or more, more preferably 8 μm or more, and most preferably 9 μm or more. The upper limit thereof is preferably 40 μm or less, more preferably 35 μm or less, and most preferably 30 μm or less.

In the case where the film thickness is too thin, there is a tendency that the film may be easily broken, mechanical strength and performance become insufficient, and in a process of assembling the power-storage device, transporting failure, winding failure, and the like may occur, which is not preferable. In the case where the film thickness is too thick, there is a tendency that the ionic conductivity may decrease, and this does not match the design of a power-storage device with high capacity and small size, which is not preferable.

The thickness of the micro porous film can be measured by analyzing an image of a cross-section of the micro porous film taken by a scanning electron microscope (SEM), or the thickness can be measured by a dot type thickness measuring apparatus or the like.

The air permeability (gas permeation rate) of the micro porous film is preferably 80 sec/100 cc or more, more preferably 90 sec/100 cc or more, and most preferably 100 sec/100 cc or more. The upper limit thereof is preferably 800 sec/100 cc or less, more preferably 700 sec/100 cc or less, and most preferably 600 sec/100 cc or less.

In the case where the air permeability is too high, the flow of ions in the power-storage device is suppressed when the micro porous film is used as the separator for the power-storage device, which is not preferable. The lower the air permeability is, the lower the resistance of the power-storage device becomes, which is preferable. On the other hand, in the case where the air permeability is too low, the flow of ions becomes too fast, the temperature rises at the time of failure increases, which is inappropriate. In addition, in the case where the air permeability is too low, the balance with characteristics such as porosity and strength is impaired. Therefore, an appropriate range of the air permeability is present.

The maximum pore diameter of the micro porous film used as the separator for the power-storage device is preferably 0.05 μm or more and 2 μm or less, and more preferably 0.08 μm or more and 0.5 μm or less. In the case where the maximum pore diameter is too small, the mobility of ions is poor (low) when the micro porous film is used as the separator for the power-storage device, and the resistance increases, which is inappropriate. In the case where the maximum pore size is too large, the mobility of ions is too high when the micro porous film is used as the separator for the power-storage device, which is inappropriate.

The peeling strength (delamination strength) of the micro porous film is preferably in a range of 3 g/15 mm or more and 90 g/15 mm or less, and more preferably 3 g/15 mm or more and 80 g/15 mm or less. In the case where the interlaminar peeling strength (interlaminar delamination strength) of the micro porous film is low, for example, peeling-off, curling, and elongation of a film are likely to occur in a process of producing the separator for the power-storage device, which causes problems in terms of product quality.

The porous film of the embodiment may include a high porosity layer containing an organic binder on one surface or both surfaces of the micro porous film. Specifically, an ink component in which an organic binder, an organic binder and inorganic particles, or an organic binder and organic particles is dispersed in a solvent consisting of water, an organic solvent, or a mixture thereof may be coated on one surface or both surfaces of the micro porous film, and the resultant may be thereafter subjected to a drying process; and thereby, the high porosity layer having a higher porosity than the micro porous film may be formed. Since the high porosity layer has a higher porosity than the micro porous film, the high porosity layer does not hinder the function of the porous film as the separator. In addition, the ink component may contain, as necessary, a thickener such as xanthan gum, a dispersant such as aqueous ammonium polycarbonate, and the like.

As the organic binder that configures the high porosity layer, one type or a mixture of two or more types selected from the group consisting of an acrylic resin (an ethylene-acrylic acid copolymer such as an ethylene-ethyl acrylate copolymer), styrene butadiene rubber (SBR), a polyolefin-based resin (an ethylene-vinyl acetate copolymer (EVA, one having a structural unit derived from vinyl acetate in an amount of 20 to 35 mol %)), polytetrafluoroethylene, polyvinylidene fluoride, polyacrylonitrile, polymethyl methacrylate, polyacrylic acid, hydroxyethyl cellulose (HEC), polyvinyl alcohol (PVA), polyvinyl butyral (PVB), polyvinyl pyrrolidone (PVP), a crosslinked acrylic resin, polyurethane, an epoxy resin, carboxymethyl cellulose (CMC), and modified polybutyl acrylate.

Among these, in particular, the organic binder is preferably one type or a mixture of two or more types selected from the group consisting of an acrylic resin, styrene butadiene rubber, a polyolefin-based resin, polytetrafluoroethylene, polyvinylidene fluoride, polyacrylonitrile, polymethyl methacrylate, and polyacrylic acid.

In particular, a heat-resistant organic binder having a heat-resistant temperature of 150° C. or higher is preferably used.

The organic particles contained in the high porosity layer are preferably one type or a mixture of two or more types selected from a polyethylene-based resin consisting of high-density polyethylene, low-density polyethylene, linear low-density polyethylene, or the like, a polypropylene-based resin, an acrylic resin, and a polystyrene-based resin.

In addition, the shape of the organic particles is preferably any of a spherical shape, elliptical shape, a substantially spherical shape, a desert rose shape, and a flat shape.

The mode particle diameter (diameter showing the maximum frequency in the size distribution) of the organic particles is preferably 0.1 μm or more, more preferably 0.3 μm or more, and most preferably 0.5 μm or more. The upper limit thereof is preferably 5.0 μm or less, more preferably 3.0 μm or less, most preferably 2.0 μm or less. The mode particle diameter of the organic particles can be obtained, for example, by photographing the high porosity layer with a scanning electron microscope (SEM), measuring the particle diameters of a plurality of the organic particles, and calculating the mode diameter from the measured result.

It is desirable that the inorganic particles contained in the high porosity layer are stable with respect to the electrolytic solution of the power-storage device and the inorganic particles are electrochemically stable such that the inorganic particles are less likely to be oxidized and reduced in an operating voltage range of the power-storage device. It is preferable that the inorganic particles (inorganic filler) are one type or a mixture of two or more types selected from the group consisting of alumina, alumina hydrate, zirconia, magnesia, aluminum hydroxide, magnesium hydroxide, magnesium carbonate, boehmite, and silica. With regard to the high porosity layer in which the inorganic particles are used, the heat resistance can be increased without increasing resistance to gas permeation, which is preferable. Among these inorganic particles, boehmite, alumina, and silica (SiO₂) are particularly preferable.

The shape of the inorganic particles is not particularly limited, and a plate shape, a granular shape, a fibrous shape, and the like are suitably used. Particularly in the case where plate-like inorganic particles are used as the inorganic particles, the path between the positive electrode and the negative electrode in the high porosity layer, that is, so-called tortuosity increases. Therefore, even in the case where dendrites are formed in the porous film used as the separator, it is difficult for the dendrites to reach the positive electrode from the negative electrode, and reliability against dendrite short circuits can be enhanced, which is preferable.

With regard to the particle diameter of the inorganic particles, the average particle diameter is, for example, preferably 0.01 μm or more, and more preferably 0.1 μm or more. The upper limit thereof is preferably 10 μm or less, and more preferably 2 μm or less.

The average particle diameter mentioned in this specification is, for example, D50% (particle diameter at a cumulative fraction of 50% in terms of volume) which is measured using a laser scattering particle size distribution meter (for example, “LA-920” manufactured by HORIBA, Ltd.) under conditions where the inorganic particles are dispersed in a medium and the medium does not dissolve the inorganic particles.

The power-storage device of the embodiment is a power-storage device including at least a positive electrode, a negative electrode, a separator interposed between the positive electrode and the negative electrode, and a non-aqueous electrolytic solution with which the separator is impregnated. In the power-storage device of the embodiment, the separator includes (or consists of) any one of the above-described porous films. The porous film used as the separator may be a single sheet or a plurality of sheets.

In the power-storage device of the embodiment, the separator may be the porous film including a high porosity layer among the porous film described above, and the high porosity layer of the porous film may be disposed so as to be in contact with the negative electrode surface.

As the arrangement of the micro porous film and the high porosity layer that configure the single sheet or the plurality of sheets of the porous film used as the separator, specifically, a configuration of the high porosity layer and the micro porous film, a configuration of the high porosity layer, the micro porous film, and the high porosity layer, a configuration of the high porosity layer, the micro porous film, the high porosity layer, and the micro porous film, or a configuration of the high porosity layer, the micro porous film, the high porosity layer, the micro porous film, and the high porosity layer is preferable when describing components in order from the surface facing the negative electrode surface.

In particular, when the high porosity layer in which the inorganic particles are dispersed is disposed as the high porosity layer in contact with the negative electrode, the resistance of the power-storage device is decreased, which is preferable.

The separator may include (or consist of) a first porous film which is the porous film including (or consisting of) the micro porous film and a second porous film which is the porous film including the high porosity layer on one surface of the micro porous film, and the high porosity layer of the second porous film may be disposed in contact with the first porous film. In this case, when a layer containing organic particles is disposed as the high porosity layer interposed between the micro porous films, the resistance of the power-storage device is decreased, which is more preferable.

In the case where the micro porous film that configures the porous film is disposed in contact with the negative electrode, as the arrangement of the micro porous film and the high porosity layer that configure the single sheet or the plurality of sheets of the porous film used as the separator, a configuration of the micro porous film, the high porosity layer, and the micro porous film, or a configuration of the micro porous film, the high porosity layer, the micro porous film, and the high porosity layer is preferable when describing components in order from the surface facing the negative electrode surface.

The power-storage device of the embodiment has a low resistance value measured by DC-R (direct-current resistance) measurement. Specifically, the resistance value of the power-storage device is preferably 0.70 ohm or less, more preferably 0.65 ohm or less, and most preferably 0.62 ohm or less.

In the case where the resistance value of the power-storage device is too high, the output characteristics of the power-storage device are deteriorated, which is not preferable. The lower limit of the resistance value is not particularly limited, and the lower the resistance is, the more preferable in view of the output characteristics of the power-storage device is. In actual practice, the power-storage device of the embodiment is 0.50 ohm or more in many cases, and is 0.53 ohm or more in even more cases.

The power-storage device including the porous film of the embodiment as the separator has favorable dendrite resistance. Specifically, it is preferable that charging and discharging can be performed in a charge and discharge test under conditions where lithium metal is used for the negative electrode of the power-storage device.

Hereinafter, an example in which the porous film of the embodiment is used as the separator included in the power-storage device such as a lithium-ion secondary battery, a lithium-ion capacitor, or the like will be described. For example, the shape of the separator (porous film) may be appropriately adjusted according to the shape of the power-storage device such as a lithium-ion secondary battery or the like. Similarly, the shapes of the positive electrode and the negative electrode may be appropriately adjusted according to the shape of the power-storage device such as a lithium-ion secondary battery or the like.

The separator includes (or consists of) the porous film of the embodiment. The separator has a single-layer structure or a multi-layer structure. The separator may consist of only the micro porous film, but the separator may include the micro porous film, and a heat-resistant layer and/or a functional layer which consist of a high porosity layer formed on the surface of the micro porous film, and the separator may further include an adhesive layer. It is preferable that the heat-resistant layer and/or the functional layer have a higher porosity than the micro porous film. However, the adhesive layer is not limited thereto.

As the high porosity layer, a functional layer formed by coating an ink component in which at least an organic binder and organic particles are dispersed may be disposed.

In the case where the porous film includes the heat-resistant layer consisting of the high porosity layer on one surface or both surfaces of the micro porous film, it can be expected that a function of suppressing thermal shrinkage of the micro porous film and preventing an internal short circuit in the power-storage device caused by breakage of the micro porous film is enhanced.

The heat-resistant layer, the adhesive layer, the functional layer, and the like may be provided on only one surface of the micro porous film or on both surfaces thereof. In addition, the heat-resistant layer, the adhesive layer, the functional layer, and the like may be each independently provided or may be laminated as a plurality of layers.

In the power-storage device, the separator is disposed between the negative electrode and the positive electrode such as the configuration of the negative electrode, the separator, the positive electrode, the separator, the negative electrode, and so on when describing components in order. In the case where the porous film used as the separator is the porous film in which the high porosity layer is provided on one surface of the micro porous film, the high porosity layer may be provided facing the positive electrode, or may be provided facing the negative electrode.

Specifically, in the case where the heat-resistant layer as the high porosity layer is disposed facing the positive electrode, safety is improved, which is preferable. In the case where the heat-resistant layer as the high porosity layer is disposed facing the negative electrode, the life of the power-storage device is improved, which is preferable. In addition, in a case where heat-resistant layer as the high porosity layer is disposed facing the negative electrode, resistance is decreased, which is preferable.

In the case where an organic functional layer as the high porosity layer is disposed facing the positive electrode, the resistance of the device is decreased, which is preferable. In the case where the organic functional layer as the high porosity layer is provided facing the negative electrode, the life of the power-storage device is improved, which is preferable.

In the case where the high porosity layer is disposed on both surfaces of the micro porous film, and in the case where the heat-resistant layer as the high porosity layer is disposed on one surface and the organic functional layer as the high porosity layer is disposed on the other surface, when the heat-resistant layer is disposed facing the negative electrode, the life of the power-storage device is improved, which is preferable. In addition, the resistance is decreased, which is preferable. Furthermore, when the heat-resistant layer is disposed facing the positive electrode, the life of the power-storage device is improved, which is preferable.

In the case where the heat-resistant layer as the high porosity layer is disposed on both surfaces of the micro porous film, and in the case where the organic functional layer as the high porosity layer is disposed on both surfaces thereof, the case of disposing the heat-resistant layer is preferable from the viewpoint of the life of the power-storage device or a decrease in resistance. In addition, the case where the organic functional layer as the high porosity layer is disposed on both surfaces may be preferable in some cases in consideration of functions required for the power-storage device.

In the case where the high porosity layer is disposed between the micro porous films, the resistance of the power-storage device is decreased, which is preferable. Furthermore, the life of the power-storage device is improved, which is preferable. In the case where the heat-resistant layer as the high porosity layer is disposed, heat resistance is also improved, which is preferable. In the case where the functional layer as the high porosity layer is provided, not only are the decrease in the resistance of the power-storage device and the improvement of the life are achieved, but also the function of the functional layer can be imparted, which is preferable.

As the resin material of the micro porous film, for example, a polyolefin-based resin such as PE (polyethylene), PP (polypropylene), or the like can be used. The structure of the micro porous film may be a single-layer structure or a multi-layer structure. As the multi-layer structure, a three-layer structure consisting of a PP layer, a PE layer laminated on the PP layer, and a PP layer laminated on the PE layer can be employed. The number of layers of the multi-layer structure is not limited to three, and may be two or four or more.

The weight-average molecular weight of polypropylene is preferably 460,000 to 540,000. In particular, the lower limit thereof is preferably 465,000 or more, more preferably 470,000 or more, particularly preferably 475,000 or more, and most preferably 490,000 or more. The weight-average molecular weight of polyethylene is preferably from 200,000 to 420,000, and may be appropriately selected from this range. By increasing the molecular weight of polypropylene, an increase in the strength of the separator and the like can be expected. However, difficulty in production may also be expected.

As the micro porous film, for example, a uniaxially stretched or biaxially stretched polyolefin micro porous film may be suitably used. In particular, a polyolefin micro porous film uniaxially stretched in the longitudinal direction (MD direction) has a low degree of thermal shrinkage in a width direction while having appropriate strength and is thus particularly preferable. In the case where the separator including the uniaxially stretched polyolefin micro porous film is wound together with long sheet-like positive and negative electrodes, it is also possible to suppress thermal shrinkage in the longitudinal direction. Therefore, the porous film including the polyolefin micro porous film uniaxially stretched in the longitudinal direction is particularly suitable as a separator included in a wound electrode body.

Hereinafter, a process of producing the micro porous film of the separator described above will be described.

The micro porous film can be produced through three processes including a web producing process, a lamination process, and a stretching process. The micro porous film can also be produced through a process of producing a web in which three layers are laminated using a multi-layer web forming apparatus for three layers with two types, and a subsequent stretching process.

In addition, in the case where a micro porous film of a PE or PP single layer is produced, and in the case where a micro porous film is produced using a laminated web formed by the multi-layer web forming apparatus, the lamination process may be omitted.

In the case where a micro porous film consisting of a multi-layered polyolefin layer is produced, polypropylene and polyethylene included in each layer may have the same molecular weight or different molecular weights in each layer. It is preferable that polypropylene has high tacticity. In addition, as polyethylene, high-density polyethylene having a density of 0.960 or higher is more preferable, but medium-density polyethylene may also be used. Polypropylene and/or polyethylene may contain additives such as a surfactant, an anti-aging agent, a plasticizer, a flame retardant, or a colorant.

### [Web Process]

A web for producing the micro porous film may have a uniform thickness and a property that form pores by being stretched after a plurality of sheets are laminated. As a forming method of the web, a melt forming using a T-die is suitable, but an inflation method, a wet solution method, or the like may also be adopted.

In order to produce a plurality of films, in the case where the films are separately subjected to the melt forming using the T-die, the melt forming is generally performed at a temperature higher than each resin melting temperature by 20° C. to 60° C., and a draft ratio of 10 or more and 1000 or less, and preferably 50 or more and 500 or less.

The take-up speed is not particularly limited, and forming is generally performed at 10 m/min or higher and 200 m/min or lower. The take-up speed affects the characteristics of the finally obtained micro porous film (the birefringence and elastic recovery ratio, and the pore diameter, porosity, interlaminar peeling strength, mechanical strength, and the like of the micro porous film after being stretched); and therefore, the take-up speed is important.

In addition, in order to suppress the surface roughness of the micro porous film to a predetermined value or lower, the uniformity of the thickness of the web is important. It is preferable that the coefficient of variation (C.V.) in the thickness of the web is adjusted to a range of 0.001 to 0.030.

### [Lamination Process]

In the embodiment, a process of laminating a polypropylene film and a polyethylene film produced in the web process will be described as an example of the lamination process.

The polypropylene film and the polyethylene film are laminated into a laminated film by thermal compression bonding. Lamination of a plurality of films is performed through the thermal compression bonding by passing the laminated film between heated rolls. Specifically, the films are unwound (wound off) from a plurality of sets of web roll stands, and the films are nipped between the heated rolls such that the films are compression-bonded and laminated. During the lamination, it is necessary to perform the thermal compression bonding so as not to substantially decrease the birefringence and the elastic recovery ratio of each film.

Regarding the layer configuration of the laminated film, for example, in the case where the layer configuration includes three layers, there is a case (PP/PE/PP) where the three layers are laminated such that the front and the rear of the three layers are made of polypropylene and the center is made of polyethylene, that is, the outer layers are made of polypropylene and the inner layer is made of polyethylene. In addition, there is a case (PE/PP/PP) where the three layers are laminated such that the outer layer is made of polyethylene and the inner layers are made of polypropylene. In the case where the layer configuration includes two layers, there is a case (PE/PE) where two layers of polyethylene are adhered to each other. Although the layer configuration of the laminated film is not limited, the case (PP/PE/PP) where the three layers are laminated such that the outer layers are made of polypropylene and the inner layer is made of polyethylene is most preferable in view of satisfying characteristics such as no curling, low susceptibility to external damage, good heat resistance and mechanical strength of the polyolefin micro porous film, safety and reliability as the separator for the power-storage device, and the like.

The temperature of the rolls heated for thermal compression bonding of a plurality of layers (thermal compression bonding temperature) is preferably 120° C. or higher and 160° C. or lower, and more preferably 125° C. or higher and 150° C. or lower. In the case where the thermal compression bonding temperature is too low, the peeling strength between the films is weak, and peeling occurs in the subsequent stretching process. Contrary to this, in the case where the thermal compression bonding temperature is too high, polyethylene is melted when the polyethylene film is subjected to thermal compression bonding. As a result, the birefringence and elastic recovery ratio of the polyethylene film are greatly reduced, and the separator for the power-storage device including the polyolefin micro porous film satisfying the desired object cannot be obtained.

The thickness of the laminated film is not particularly limited, and is generally 9 μm or more and 60 μm or less.

In the case of a single PE layer, a single PP layer, a film produced by the multi-layer web forming apparatus, or the like which does not need to be laminated in the lamination process, the lamination process may be omitted.

[Stretching Process]

The laminated film, the single PE layer film, or the single PP layer film is made porous in the stretching process. In the case of the laminated film, the PP and PE layers are simultaneously made porous in the stretching process.

The stretching process is performed in four zones including a heat treatment zone (oven 1), a cold stretching zone, a hot stretching zone (oven 2), and a heat fixing zone (oven 3).

When the laminated film is made porous, the laminated film is heat-treated in the heat treatment zone before being stretched. The heat treatment is performed in a heated air convection oven or a heated roll while the laminated film has a fixed length or the laminated film is pulled at a tension of 10% or less. The heat treatment temperature is preferably 110° C. or higher and 150° C. or lower, and more preferably 115° C. or higher and 140° C. or lower. In the case where the heat treatment temperature is low, pore formation is insufficient. In the case where the heat treatment temperature is too high, polyethylene is melted when the micro porous film containing polyethylene is produced, which is inappropriate. The heat treatment time may be three seconds or longer and three minutes or shorter.

The heat-treated laminated film is subjected to low-temperature stretching in the cold stretching zone and then the heat-treated laminated film is subjected to high-temperature stretching in the hot stretching zone to become porous, resulting in a laminated porous film. Polypropylene and polyethylene cannot become sufficiently porous by only either one stretching of the low-temperature stretching or the high-temperature stretching, and the characteristics as the separator for the power-storage device deteriorate.

The temperature of the low-temperature stretching in the cold stretching zone is preferably −20° C. or higher and +50° C. or lower, and particularly preferably 20° C. or higher and 40° C. or lower. In the case where the temperature of the low-temperature stretching is too low, the film is easily broken during operation, which is not preferable. On the other hand, in the case where the temperature of the low-temperature stretching is too high, pore formation becomes insufficient, which is not preferable. The low-temperature stretching ratio is preferably 3% or higher and 200% or lower, and more preferably 5% or higher and 100% or lower. In the case where the low-temperature stretching ratio is too low, only a micro porous film having a low porosity is obtained. In the case where the low-temperature stretching ratio is too high, a micro porous film having a predetermined porosity and a predetermined pore diameter are not obtained. Therefore, the above-described range is appropriate.

Then, the low-temperature stretched laminated film is subjected to the high-temperature stretching in the hot stretching zone. The temperature of the high-temperature stretching is preferably 70° C. or higher and 150° C. or lower, and particularly preferably 80° C. or higher and 145° C. or lower. In the case where the temperature is out of this range, sufficient pore formation is not achieved, which is inappropriate. The high-temperature stretching ratio (maximum stretching ratio) is preferably in a range of 100% to 400%. In the case where the maximum stretching ratio is too low, the gas permeability is low. In the case where the maximum stretching ratio is too high, the gas permeability is too high. Therefore, the above range-described is appropriate.

After the low-temperature stretching and the high-temperature stretching, thermal relaxation is performed in an oven. The thermal relaxation is performed to prevent contraction (shrinkage) of the film in the stretching direction due to residual stress exerted during the stretching. During the thermal relaxation, thermal shrinkage is caused such that the film length after the stretching is reduced in advance by a range of 10% to 300%.

The temperature during the thermal relaxation is preferably 70° C. or higher and 145° C. or lower, and particularly preferably 80° C. or higher and 140° C. or lower. In the case where the temperature is too high, the PE layer is melted when the micro porous film containing polyethylene is produced, and thus the film is inappropriate as the separator. In the case where the temperature is too low, the thermal relaxation is insufficiently performed, and the thermal shrinkage ratio of the separator is high, which is not preferable. In addition, in the case where the thermal relaxation process is not performed, the thermal shrinkage ratio of the micro porous film increases, which is not preferable for the separator for the power-storage device.

The heat-treated film that has passed through the hot stretching zone is then subjected to a heat treatment for heat fixing while the dimensions thereof in the hot stretching direction are regulated so as not to change in the heat fixing zone. The heat fixing is performed in the heated air convection oven or the heated roll while the heat-treated film has a fixed length (0%) or the heat-treated film is pulled at a tension of 10% or less. The heat fixing temperature is preferably 110° C. or higher and 150° C. or lower, and more preferably in a range of 115° C. to 140° C. In the case where the temperature is low, a sufficient heat fixing effect is not obtained, and the thermal shrinkage ratio increases. In the case where the temperature is too high, polyethylene is melted when the micro porous film containing polyethylene is produced, which is inappropriate.

In the embodiment, the micro porous film which has excellent compression characteristics and good dimensional stability, satisfies the desired object, and has high interlaminar peeling strength can be obtained by laminating the webs having excellent thickness precision and performing heat fixing after stretching and thermal shrinkage.

In the embodiment, the laminated film may be produced by the above-described processes in which a plurality of webs are separately produced and laminated into multiple layers, or the laminated film may also be produced by using a method (coextrusion method) in which resins extruded by individual extruders are joined in a die and are simultaneously extruded. The web film (laminated film) having the multi-layer structure obtained by using the coextrusion method is subjected to the same stretching process as described above; and thereby, the micro porous film which has excellent compression characteristics and good dimensional stability, satisfies the desired object, and has high interlaminar peeling strength is obtained.

A heat-resistant layer may be provided on one surface or both surfaces of the micro porous film by mixing inorganic particles and an organic binder together and performing a process of coating the mixture thereon, or the like. Furthermore, an adhesive layer may also be provided by coating a fluororesin or the like on one surface or both surfaces of the micro porous film. Furthermore, a functional layer may also be provided on one surface or both surfaces of the micro porous film by mixing organic particles or the like and an organic binder together and performing a process of coating the mixture thereon, or the like.

The heat-resistant layer, the adhesive layer, and the functional layer may be each disposed as a single layer or a plurality of layers. In addition, as a processing method, a plurality of layers may be laminated by a plurality of coating processes, or a layer provided with a plurality of functions may be disposed by a method of mixing materials of two or more types of layers selected from a heat-resistant layer, an adhesive layer, and a functional layer and coating the mixture or the like.

In particular, it is preferable that the compression characteristics are not greatly deteriorated even when the heat-resistant layer is applied, and for example, a known method described in Patent Document 3 can be used.

### [Non-Aqueous Electrolytic Solution]

As a non-aqueous solvent used in the non-aqueous electrolytic solution included in the power-storage device of the embodiment, a cyclic carbonate and a chain ester are suitably employed. In order to synergistically improve the electrochemical characteristics in a wide temperature range, particularly at a high temperature, it is preferable that the chain ester is contained, it is more preferable that a chain carbonate is contained, and it is most preferable that both the cyclic carbonate and the chain carbonate are contained. The term “chain ester” is used as a concept including the chain carbonate and a chain carboxylic acid ester.

As the cyclic carbonate, one or two or more selected from ethylene carbonate (EC), propylene carbonate (PC), and vinylene carbonate (VC) can be employed, and a combination of EC and VC, and a combination of PC and VC are particularly preferable.

In addition, in the case where the non-aqueous solvent contains ethylene carbonate and/or propylene carbonate, the stability of the coating formed on the electrode increases and the high-temperature and high-voltage cycle characteristics are improved. The content of ethylene carbonate and/or propylene carbonate is preferably 3 vol % or more, more preferably 5 vol % or more, and even more preferably 7 vol % or more with respect to the total volume of the non-aqueous solvent. The upper limit thereof is preferably 45 vol % or less, more preferably 35 vol % or less, and even more preferably 25 vol % or less.

As the chain ester, methyl ethyl carbonate (MEC) as an asymmetric chain carbonate, dimethyl carbonate (DMC), diethyl carbonate (DEC) as a symmetric chain carbonate, and ethyl acetate (hereinafter, referred to as EA) as the chain carboxylic acid ester are suitably employed. Among the chain esters, a combination of chain esters which are asymmetric and contain an ethoxy group, such as MEC and EA, is possible.

The content of the chain ester is not particularly limited, but is preferably used in a range of 60 to 90 vol % with respect to the total volume of the non-aqueous solvent. In the case where the content thereof is 60 vol % or more, the viscosity of the non-aqueous electrolytic solution does not become excessively high. In the case where the content thereof is 90 vol % or less, there is less concern about a reduction in the electrical conductivity of the non-aqueous electrolytic solution and the deterioration in the electrochemical characteristics in a wide temperature range, particularly at a high temperature. Therefore, the above-described range is preferable.

Among the chain esters, the proportion of the volume of EA is preferably 1 vol % or more, and more preferably 2 vol % or more in the non-aqueous solvent. The upper limit thereof is more preferably 10 vol % or less, and more preferably 7 vol % or less. The asymmetric chain carbonate preferably has an ethyl group, and is particularly preferably methyl ethyl carbonate.

The ratio between the cyclic carbonate and the chain ester (volume ratio) is preferably 10:90 to 45:55, more preferably 15:85 to 40:60, and particularly preferably 20:80 to 35:65 from the viewpoint of improving the electrochemical characteristics in a wide temperature range, particularly at a high temperature.

### [Electrolyte Salt]

As the electrolyte salt used in the power-storage device of the embodiment, a lithium salt is suitably employed.

As the lithium salt, one or two or more selected from the group consisting of LiPF₆, LiBF₄, LiN(SO₂F)₂, and LiN(SO₂CF₃)₂ is preferable, one or two or more selected from LiPF₆, LiBF₄, and LiN(SO₂F)₂ is more preferable, and LiPF₆ is most preferably used.

### [Production of Non-Aqueous Electrolytic Solution]

The non-aqueous electrolytic solution used in the power-storage device of the embodiment is obtained by, for example, a method of mixing the non-aqueous solvent mentioned above and adding thereto the electrolyte salt mentioned above and a composition obtained by mixing a dissolution aid and the like in specific mixing ratios with respect to the non-aqueous electrolytic solution. At this time, as a compound to be added to the non-aqueous solvent and the non-aqueous electrolytic solution that are used, it is preferable to use those which are purified in advance and thus contain an extremely small amount of impurities in a range in which the productivity is not greatly reduced.

The porous film of the embodiment can be used in the following first and second power-storage devices, and as the non-aqueous electrolyte, not only a liquid electrolyte but also a gelated electrolyte can be used. In particular, the porous film is preferably used as a separator for a lithium-ion battery (first power-storage device) or a lithium-ion capacitor (second power-storage device) in which a lithium salt is used as an electrolyte salt, the porous film is more preferably used for a lithium-ion battery, and the porous film is even more preferably used for a lithium-ion secondary battery.

### [Lithium-Ion Secondary Battery]

A lithium-ion secondary battery as the power-storage device of the embodiment includes a positive electrode, a negative electrode, the porous film of the embodiment as a separator, and the non-aqueous electrolytic solution in which the electrolyte salt is dissolved in the non-aqueous solvent. Constituent members such as the positive electrode and the negative electrode can be used without particular limitations.

For example, as a positive electrode active material for the lithium-ion secondary battery, a composite lithium metal oxide containing one or two or more selected from the group consisting of iron, cobalt, manganese, and nickel is used. One of these positive electrode active materials can be solely used or combination of two or more thereof can be used.

As the composite lithium metal oxide, for example, one or more selected from LiFePO₄, LiCoO₂, LiCo₁₋ₓMₓO₂ (herein, M is one or two or more elements selected from Sn, Mg, Fe, Ti, Al, Zr, Cr, V, Ga, Zn, and Cu), LiMn₂O₄, LiNiO₂, LiCo₁₋ₓNiₓO₂, LiCo_{1/3}Ni_{1/3}Mn_{1/3}O₂, LiNi_{0.5}Mn_{0.3}Co_{0.2}Mn_{0.3}O₂, LiN_{0.8}Mn_{0.1}Co_{0.1}O₂, LiNi_{0.8}Co_{0.15}Al_{0.05}O₂, a solid solution of Li₂MnO₃ and LiMO₂ (M is a transition metal such as Co, Ni, Mn, or Fe), and LiNi_{1/2}Mn_{3/2}O₄ are suitably employed.

The conducting agent of the positive electrode is not particularly limited as long as the conducting agent is an electron conductive material that does not cause a chemical change. For example, graphite such as natural graphite (flake graphite or the like) and artificial graphite, and one or two or more types of carbon black selected from acetylene black and the like can be employed.

For example, the positive electrode can be produced by the following method. The positive electrode active material described above is mixed with the conducting agent and a binder, and a solvent such as 1-methyl-2-pyrrolidone is added thereto. The mixture is kneaded; and thereby a positive electrode mixture is obtained. The positive electrode mixture is coated on an aluminum foil, a stainless steel plate, or the like of a current collector, and the coated film is dried and press-formed. Thereafter, the resultant is subjected to a heat treatment under predetermined conditions; and thereby, the positive electrode is produced.

As the binder, polytetrafluoroethylene (PTFE), polyvinylidene fluoride (PVDF), a copolymer of styrene and butadiene (SBR), a copolymer of acrylonitrile and butadiene (NBR), carboxymethyl cellulose (CMC), and the like can be employed.

As a negative electrode active material for the lithium-ion secondary battery, lithium metal, a lithium alloy, a carbon material capable of occluding or releasing lithium, tin (simple substance), a tin compound, silicon (simple substance), a silicon compound, and a lithium titanate compound such as Li₄Ti₅O₁₂ can be used, and one of these can be solely used or combination of two or more thereof can be used.

Among these, in view of the capability of occluding and releasing lithium ions, it is more preferable to use a highly crystalline carbon material such as artificial graphite, natural graphite, or the like.

In particular, it is preferable to use artificial graphite particles having a lump structure in which a plurality of flat graphite microparticles are aggregated or bonded nonparallel to each other, or particles formed by subjecting flake natural graphite to spheroidizing in which mechanical action such as compressive force, frictional force, or shear force is repeatedly applied to the flake natural graphite.

The negative electrode can be produced by using the conducting agent, the binder, and the solvent such as 1-methyl-2-pyrrolidone or the like, which are the same as those used in the production of the positive electrode. The mixture is kneaded; and thereby, a negative electrode mixture is obtained. The negative electrode mixture is coated on a copper foil or the like of a current collector, and the coated film is dried and press-formed. Thereafter, the resultant is subjected to a heat treatment under predetermined conditions.

### [Lithium-Ion Secondary Battery]

The structure of the lithium-ion secondary battery as one of the power-storage devices of the present invention is not particularly limited, and a coin type battery, a cylindrical battery, a prismatic battery, a laminated battery, or the like can be applied.

For example, a wound lithium-ion secondary battery has a configuration in which an electrode body is accommodated in a battery case together with the non-aqueous electrolytic solution. The electrode body consists of the positive electrode, the negative electrode, and the separator. The electrode body is impregnated with at least a portion of the non-aqueous electrolytic solution.

In the wound lithium-ion secondary battery, the positive electrode includes a long sheet-like positive electrode current collector, and a positive electrode mixture layer that contains the positive electrode active material and is provided on the positive electrode current collector. The negative electrode includes a long sheet-like negative electrode current collector, and a negative electrode mixture layer that contains the negative electrode active material and is provided on the negative electrode current collector.

Like the positive electrode and the negative electrode, the separator is formed in a long sheet shape. The positive electrode and the negative electrode with the separator interposed therebetween are wound in a cylindrical shape.

The battery case includes a cylindrical-bottomed case body and a lid for closing the opening of the case body. The lid and the case body are made of, for example, metal and are insulated from each other. The lid is electrically connected to the positive electrode current collector, and the case body is electrically connected to the negative electrode current collector. The lid may also serve as a positive electrode terminal, and the case body may also serve as a negative electrode terminal.

The lithium-ion secondary battery can be charged and discharged at a temperature of −40° C. to 100° C., preferably −10° C. to 80° C. In addition, as a measure against an increase in the internal pressure of the wound lithium-ion secondary battery, a method of providing a safety valve in the lid of the battery, or a method of providing a cutout in a member of the case body, a gasket, or the like of the battery can also be adopted. In addition, as a safety measure to prevent overcharging, a current interruption mechanism for interrupting current by measuring the internal pressure of the battery may also be provided in the lid.

### [Production of Wound Lithium-Ion Secondary Battery]

As an example, a production procedure for the lithium-ion secondary battery will be described below.

First, each of the positive electrode, the negative electrode, and the separator is prepared. Next, these are superimposed and wound in a cylindrical shape to assemble the electrode body. Next, the electrode body is inserted into the case body, and the non-aqueous electrolytic solution is injected into the case body. Accordingly, the electrode body is impregnated with the non-aqueous electrolytic solution. After injecting the non-aqueous electrolytic solution into the case body, the case body is covered with the lid, and the lid and the case body are sealed. The shape of the electrode body after being wound is not limited to the cylindrical shape. For example, after the positive electrode, the separator, and the negative electrode are wound, a pressure may be applied from the side to form a flat electrode body.

The lithium-ion secondary battery can be used as a secondary battery for various applications. For example, the lithium-ion secondary battery can be suitably used as a power source for a driving source such as a motor that is mounted in a vehicle such as an automobile to drive the vehicle. The type of the vehicle is not particularly limited, but examples thereof include a hybrid vehicle, a plug-in hybrid vehicle, an electric vehicle, and a fuel cell vehicle. The lithium-ion secondary battery may be solely used, or a plurality of batteries may be connected in series and/or in parallel so as to be used.

### [Lithium-Ion Capacitor]

Another power-storage device of the present invention is a lithium-ion capacitor. The lithium-ion capacitor of the embodiment includes the porous film of the embodiment as a separator, a non-aqueous electrolytic solution, a positive electrode, and a negative electrode. The lithium-ion capacitor can store energy using intercalation of lithium ions into a carbon material such as graphite or the like as the negative electrode. Examples of the positive electrode include those using an electric double layer between an activated carbon electrode and the electrolytic solution, those using a doping/dedoping reaction of a π-conjugated polymer electrode, and the like. The electrolytic solution contains at least a lithium salt such as LiPF₆ or the like.

Although the wound lithium-ion secondary battery has been described above, the present invention is not limited thereto, and may also be applied to a laminated lithium-ion secondary battery.

For example, the positive electrode or the negative electrode may be sandwiched between a pair of separators and packaged. In the embodiment, the positive electrode is a packaged electrode. The separators have a size slightly larger than the electrodes. While the bodies of the electrodes are interposed between the pair of separators, tabs extending from the end portions of the electrodes are allowed to protrude outward from the separators. The overlapping side edges of the pair of separators are joined together and the electrodes are packaged, one electrode and the other electrode packaged by the separators are alternately laminated and impregnated with the electrolytic solution; and thereby, a laminated battery is produced. At this time, for a reduction in thickness, the separators and the electrodes may be compressed in the thickness direction.

### EXAMPLES

Next, the present invention will be described in more detail with reference to examples, but the present invention is not limited to these examples.

Regarding a micro porous film produced in the following method and a battery produced using the micro porous film, the following items were evaluated by the following method.

In addition, regarding a web produced when the micro porous film of the examples was produced, the coefficient of variation of the thickness was obtained by the following method. Furthermore, the weight-average molecular weight and the molecular weight distribution of polypropylene and polyethylene used as the materials of the web were measured by the following method.

### [Coefficient of Variation (C.V.) of Thickness]

The coefficient of variation (C.V.) of the thickness of the web was obtained by dividing the standard deviation of thickness measurement results at 25 points in the width direction

(\sqrt{σ²})

by the arithmetic average

(X̅).

The coefficient of variation (C.V.) was evaluated as an indicator of thickness variation in the film width direction.

### [Weight-Average Molecular Weight and Molecular Weight Distribution]

The weight-average molecular weight and the molecular weight distribution of a PE raw material resin and a PP raw material resin were obtained in terms of standard polystyrene using the V200 type gel permeation chromatograph manufactured by Waters Corporation. Two columns of Shodex AT-G (manufactured by SHOWA DENKO K.K.) and AT806MS (manufactured by SHOWA DENKO K.K.) were used, and measurement was performed at 145° C. in ortho-dichlorobenzene under the condition where the concentration was adjusted to 0.3 wt/vol %. A differential refractometer (RI) was used as a detector.

### [Film Thickness Measurement]

Five test pieces having a tape shape over the entire width and a length of MD of 50 mm were prepared from the produced micro porous film. The five test pieces were stacked and thicknesses were measured at equal intervals in the width direction by an electric micrometer manufactured by Feinpruf GmbH (Millitron 1240 probe 5 mmϕ (flat surface, needle pressure 0.75 N)) such that the number of measurement points was 25. The value of 1/5 of the measurement values was used as the thickness of each test piece at each point, and the average value thereof was calculated and used as the film thickness.

### [Surface Roughness]

Regarding the surface roughness of the micro porous film, an image in a range of 1270 μm in the MD direction (longitudinal direction)×960 μm in the TD direction (width direction) was taken at an objective lens magnification of 5 times using a white-light interferometer (Vertscan 3.0) manufactured by Ryoka Systems Inc. Line analysis was performed on arbitrary two points in the MD direction of the taken image, and the surface roughness (Ra) thereof was measured. The same measurement was performed on the front and rear of the micro porous film, and the average value thereof was evaluated as Ra (ave). In addition, the surface roughnesses of micro porous films disclosed in Examples 1 to 4, which will be described later, were all in a range of 0.11 μm to 0.28 μm.

### [Measurement of Air Permeability (Gurley Value)]

A test piece having the entire width of 80 mm in the MD direction was taken from the produced micro porous film, and measurement was performed on three points including the center portion and the right and left end portions (50 mm inward from the end surfaces) using a B type Gurley densometer (manufactured by Toyo Seiki Co., Ltd.) according to JIS P8117. The average value of the measured values at 3 points was evaluated as a Gurley value.

### [Compressive Elastic Modulus]

A plurality of 50 mm square separator samples were taken from the produced micro porous film and were laminated to produce a 5 mm thick laminated sample. A metal cylinder having a diameter of 10 mm was pressed against the laminated sample, and a stress-strain curve in the compression direction was created by using a load cell of 500 N in RTC-1250A manufactured by ORIENTEC Co., LTD. under the condition where a chuck loss head speed was 0.5 mm/min. From the slope of a part where the slope of the stress-strain curve was constant, the compressive elastic modulus was calculated.

Herein, stress is the compressive load (N) per unit area (mm²)=the compressive stress (N/mm²), and the unit thereof is MPa. For example, in the case where a load of 100 N is applied using the metal cylinder having a diameter of 10 mm, the stress is 100 N/(5 mm×5 mm×π)=about 1.27 MPa. Strain is a value obtained by dividing the amount of displacement deformed when the compressive stress is applied, by the initial thickness (5 mm), and the strain has no unit. For example, in the case where a sample is deformed from 5 mm as the initial thickness to 4.8 mm by the test, the amount of displacement becomes 0.2 mm, and the amount of strain becomes 0.2 mm/5 mm=0.04.

### [Shutdown Temperature]

Using a self-produced electrical resistance measurement cell, the shutdown temperature of the produced micro porous film was measured. Dimethoxyethane and propylene carbonate were mixed at a volume ratio of 1: 1 (vol/vol). Lithium perchlorate was dissolved in the obtained mixed solution and the concentration was adjusted to 1 M/L to prepare a non-aqueous electrolytic solution. The produced micro porous film was immersed in the non-aqueous electrolytic solution, and the resultant was degassed to cause the non-aqueous electrolytic solution to be contained in the pores; and thereby, a sample was prepared.

The sample was interposed between nickel electrodes, and set in a measuring cell. The temperature was raised at a rate of 10° C./min The electrical resistance between the electrodes was measured using 3520 LCR HiTESTER manufactured by Hioki E. E. Corporation. The measurement was performed from room temperature, and the temperature at which the resistance value became 1000 times the initial resistance value was taken as the shutdown temperature.

### [Fibril Diameter]

The surface of the produced micro porous film was observed with a scanning electron microscope (SEM), and the size of fibrils obtained by the following method was determined as a fibril diameter.

The observation magnification may be an arbitrary magnification as long as the fibril diameter of an object to be observed can be appropriately calculated, but the object was observed at a magnification of approximately 5,000 times, 10,000 times, and 20,000 times. The diameters of ten arbitrary fibril portions arranged in the direction substantially perpendicular to the MD direction were estimated from the observed SEM image through image analysis, and the average value thereof was determined as the fibril diameter arranged in the direction perpendicular to the MD direction.

### [Pore Diameter and Surface Opening Ratio]

The SEM image from which the fibril diameter was obtained was subjected to binarization processing, and a pore diameter and a surface opening ratio were calculated through image analysis. Regarding the pore diameter, elliptic approximation was performed, and the lengths of the major axes of ellipses were determined as pore diameters, and the average value thereof was evaluated. The surface opening ratio was evaluated in percentage by calculating the total area of pore portions through binarization and dividing the calculated area by the area subjected to the image analysis.

### [DC-R (Direct-Current Resistance)Test]

90 mass % of lithium iron phosphate LiFePO₄ and 6 mass % of acetylene black (conducting agent) were mixed, and the mixture was added to a solution prepared in advance by dissolving 4 mass % of polyvinylidene fluoride (binder) in 1-methyl-2-pyrrolidone and the resultant was mixed to prepare a positive electrode mixture paste.

The positive electrode mixture paste was coated on one surface of an aluminum foil (current collector), the coated film was dried and pressed, and was cut into a predetermined size to prepare a positive electrode sheet.

80 mass % of lithium titanate Li₄Ti₅O₁₂ and 15 mass % of acetylene black (conducting agent) were mixed, and the mixture was added to a solution prepared in advance by dissolving 5 mass % of polyvinylidene fluoride (binder) in 1-methyl-2-pyrrolidone and the resultant was mixed to prepare a negative electrode mixture paste.

The negative electrode mixture paste was coated on one surface of an aluminum foil (current collector), the coated film was dried and pressed, and was cut into a predetermined size to prepare a negative electrode sheet.

The positive electrode sheet, the separator, and the negative electrode sheet were laminated in this order, and a non-aqueous electrolytic solution was added thereto to produce a laminated lithium-ion secondary battery.

As the non-aqueous electrolytic solution, an electrolytic solution containing 1.0 M of LiPF₆ and propylene carbonate (PC) and diethyl carbonate (DMC) mixed in a ratio of PC/DMC=1/2 (volume ratio) was used.

Using the prepared laminated battery (battery capacity: 60 mAh), 600 mA discharging was performed for ten seconds from a SOC (State of Charge) of 50% state under the temperature condition of 0° C., and the battery internal resistance (direct-current resistance) was calculated by the Ohm's law (R=ΔV/0.6) from the amount of voltage drop.

### [Dendrite Resistance Test]

The positive electrode sheet, the separator, and the negative electrode sheet were laminated in this order, and a non-aqueous electrolytic solution was added thereto to produce a coin type battery (CR2032).

As the non-aqueous electrolytic solution, an electrolytic solution containing 1.0 M of LiPF₆ and ethylene carbonate (EC) and methylethyl carbonate (MEC) mixed in a ratio of EC/MEC=3/7 (volume ratio) was used.

LiCoO₂ was used as the positive electrode and lithium metal was used as the negative electrode, initial charging behavior at 0.2C was observed at 25° C. in a cut-off voltage range of 2.5 to 4.2 V.

In the case where charging was completed normally, the dendrite resistance was evaluated as good (O), and in the case where charging could not be completed normally, the dendrite resistance was evaluated as poor (x).

### Example 1

Hereinafter, an example of a method of producing the porous film of the present invention will be described. However, the production method is not limited to the following, and other methods may also be used. For example, in addition to the following method, a polyolefin micro porous film may also be produced by using a coextrusion process using a T-die and performing a stretching process without a lamination process.

### [Production of PP Web]

Using a T-die having a discharge width of 1000 mm and a discharge lip opening of 2 mm, a polypropylene resin having a weight-average molecular weight of 520,000, a molecular weight distribution of 9.4, and a melting point of 161° C. was melted and extruded at a T-die temperature of 200° C. The discharged film was guided to a cooling roll at 90° C. and was cooled by cold air of 37.2° C. Then, the film was taken up at a rate of 40 m/min The obtained unstretched polypropylene film (PP web) had a film thickness of 5.2 μm, a birefringence of 16.9×10⁻³, and an elastic recovery ratio of 90% after a heat treatment at 150° C. for 30 minutes. The coefficient of variation (C.V.) for the thickness of the web of the obtained PP web was 0.016.

### [Production of PE Web]

Using a T-die having a discharge width of 1000 mm and a discharge lip opening of 2 mm, high-density polyethylene having a weight-average molecular weight of 320,000, a molecular weight distribution of 7.8, a density of 0.961 g/cm³, a melting point of 133° C., and a melt index of 0.31 was melted and extruded at 173° C. The discharged film was guided to a cooling roll at 115° C. and was cooled by cold air of 39° C. Then, the film was taken up at a rate of 20 m/min The obtained unstretched polyethylene film (PE web) had a film thickness of 9.4 μm, a birefringence of 36.7×10⁻³, an elastic recovery ratio of 39% at 50% elongation. The coefficient of variation (C.V.) for the thickness of the web of the obtained PE web was 0.016.

### [Lamination Process]

Using the unstretched PP web (PP web) and the unstretched PE web (PE web), a three-layer laminated film having a sandwich configuration with PE as the inner layer and PP as both outer layers was produced in the following manner.

From three sets of web roll sandwiches (sandwich rolls), the PP web and the PE web were unwound at a speed of 6.5 m/min, the webs were guided to a heating roll, and were subjected to thermal compression bonding by a roll at a roll temperature of 147° C. Thereafter, the resultant was guided to a cooling roll of 30° C. at the same speed and then wound up. The unwinding tension was 5.0 kg for the PP web and the unwinding tension was 3.0 kg for the PE web. The obtained laminated film had a film thickness of 19.6 μm and a peeling strength of 54.7 g/15 mm

### [Stretching Process]

The three-layer laminated film was guided to the hot air convection oven (heat treatment zone: oven 1) heated to 125° C. and was subjected to a heat treatment. Then the heat-treated laminated film was stretched at a low temperature by 18% (initial stretching ratio) between nip rolls maintained at 35° C. in a cold stretching zone. The roll speed on the supply side was 2.8 m/min Subsequently, the laminated film was subjected to hot stretching between rollers in the hot stretching zone (oven 2) heated to 130° C. using the difference between the roll circumferential speeds until 190% (maximum stretching ratio) was achieved. Thereafter, the resultant was subjected to thermal relaxation to 125% (final stretching ratio) and was then subjected to heat fixing at 133° C. in the heat fixing zone (oven 3). Thereby, a polyolefin micro porous film having a three-layer structure of PP/PE/PP was continuously obtained.

The physical properties (film thickness, air permeability (Gurley value), pore diameter, compressive elastic modulus, fibril diameter, surface porosity (surface opening ratio), and shutdown temperature) of the obtained polyolefin micro porous film were measured by the above-described methods, and the results are shown in Table 1.

In addition, the characteristics (DC-R and dendrite resistance) of a battery produced by the above-described method using the produced micro porous film as a separator were measured, and the measurement results are shown in Table 1. There was no curl in the polyolefin micro porous film, and no pinhole was observed.

### Example 2

The film thickness of the PP web of Example 1 was set to 19.0 μm and the lamination process was omitted. Thereafter, a micro porous film having a single PP layer was continuously obtained under the same conditions.

### Example 3

A micro porous film having a film thickness of 20 μm was obtained in the same manner as in Example 2 except that the film thickness of the PP web was changed.

### Example 4

A micro porous film having a film thickness of 9 μm was obtained in the same manner as in Example 2 except that the film thickness of the PP web was changed.

### Comparative Example 1

A nonwoven fabric formed of fibers made of polypropylene and polyethylene was produced by a known method.

### Comparative Example 2

A nonwoven fabric formed of cellulose fibers was produced by a known method.

The physical properties of the micro porous films of Examples 2 to 4 and the nonwoven fabrics of Comparative Examples 1 and 2 and the characteristics of batteries produced by using these in the same manner as in Example 1 were measured, and the measurement results are shown in Table 1.

TABLE 1

| | | Example | Example | Example | Example | Comparative | Comparative |
|---|---|---|---|---|---|---|---|
| | | 1 | 2 | 3 | 4 | Example 1 | Example 2 |
| Base material | | PP/PE/PP | PP | PP | PP | PP/PE | Cellulose |
| Film thickness | μm | 16 | 16 | 20 | 9 | 20 | 20 |
| Air | sec/100 | 220 | 160 | 200 | 110 | 0.2 | 3 |
| permeability | cc | | | | | | |
| Pore diameter | nm | 121 | 126 | 135 | 131 | 8700 | 820 |
| Compressive | MPa | 118 | 130 | 132 | 114 | — | — |
| elastic | | | | | | | |
| modulus | | | | | | | |
| Fibril diameter | nm | 233 | 267 | 220 | 226 | 7200 | 1300 |
| Surface | % | 12.6 | 15.7 | 18.8 | 15.1 | 32.0 | 27.0 |
| opening ratio | | | | | | | |
| Shutdown | ° C. | 133 | 165 | 164 | 165 | —* | —* |
| temperature | | | | | | | |
| DC-R | ohm | 0.61 | 0.57 | 0.57 | 0.59 | 0.91 | 0.54 |

| | | | | | | |
|---|---|---|---|---|---|---|
| Dendrite resistance | ∘ | ∘ | ∘ | ∘ | x | x |

*indicates that it did not shut down.

As shown in Table 1, in the micro porous films of Examples 1 to 4, the shutdown temperature was appropriate, and the fibril diameter arranged in the direction perpendicular to the MD direction, the pore diameter, and the surface opening ratio were in the ranges of the present invention. In addition, as shown in Table 1, the batteries in which the micro porous films of Examples 1 to 4 were used as separators had low resistance and favorable dendrite resistance.

Contrary to this, the nonwoven fabric of Comparative Example 1 did not shut down. In the nonwoven fabric of Comparative Example 1, the fibril diameter and the pore diameter were out of the ranges of the present invention. Furthermore, the battery in which the nonwoven fabric of Comparative Example 1 was used as a separator had high resistance and poor dendrite resistance.

The nonwoven fabric of Comparative Example 2 did not shut down. In the nonwoven fabric of Comparative Example 2, the fibril diameter and the pore diameter were out of the ranges of the present invention. Furthermore, the battery in which the nonwoven fabric of Comparative Example 2 was used as a separator had poor dendrite resistance.

### Example 5

5 kg of ion-exchanged water and 0.5 kg of a dispersant (aqueous ammonium polycarbonate, solid content concentration 40%) were added to 5 kg of secondary aggregates of boehmite, and the resultant mixture was subjected to crushing process by a ball mill having an internal volume of 20 L at a rotation frequency of 40 rev/min for 8 hours to prepare a dispersion liquid. The prepared dispersion liquid was subjected to vacuum drying at 120° C. The resultant was observed by SEM, and it was confirmed that the shape of boehmite was substantially a plate shape. The average particle diameter (D50%) of boehmite was measured by a laser scattering particle size distribution meter (“LA-920” manufactured by HORIBA, Ltd.) under the conditions where a refractive index was set to 1.65, and the average particle diameter thereof was 1.0 μm.

0.5 g of xanthan gum as a thickener and 17 g of a resin binder dispersion (modified polybutyl acrylate, solid content 45 mass %) as a binder were added to 500 g of the above-described dispersion liquid, and the resultant mixture was stirred in a three-one motor for three hours to prepare a uniform slurry A (solid content ratio 50 mass %).

13 g of the above-described resin binder dispersion was added to 500 g of a low molecular weight PE dispersion (PE having a melting point of 110° C., a particle diameter of 0.6 μm, and a solid content of 40%), and the resultant mixture was stirred in a three-one motor for three hours to prepare a uniform slurry B (solid content ratio 40 mass %).

The micro porous film of Example 1 was used as a base material, the surface thereof was subjected to a corona discharge treatment (discharge amount 40 W·min/m²), and the slurry A was coated thereon by a microgravure coater to form a high porosity layer A. The thickness of the high porosity layer A after drying was 4 μm and the porosity thereof was 55%. Subsequently, the slurry B was coated on the surface of the base material which was opposite to the high porosity layer A to form a high porosity layer B. The thickness of the high porosity layer B after drying was 2 μm and the porosity thereof was 55%.

As a result, a separator film (porous film) of Example 5 was obtained, and the separator included the high porosity layer A (inorganic particle layer) on one surface of the micro porous film of Example 1 and the high porosity layer B (organic particle layer) on the other surface thereof.

### Example 6

A high porosity layer A (inorganic particle layer) was formed on one surface of the micro porous film of Example 2 in the same manner as in Example 5 except that the micro porous film of Example 2 was used as the base material. Thereafter, a high porosity layer B (organic particle layer) was formed on the other surface of the micro porous film of Example 2; and thereby, a separator film (porous film) of Example 6 was formed. The thickness of the high porosity layer A was 4 μm and the porosity thereof was 55%. The thickness of the high porosity layer B was 2 μm and the porosity thereof was 55%.

### Example 7

A micro porous film was used as a base material, and the micro porous film was formed of a 5 μm thick single PP layer produced in the same manner as in Example 2 except that the film thickness of the PP web was changed. A high porosity layer A (inorganic particle layer) was formed on only one surface of the micro porous film in the same manner as in Example 5; and thereby, a separator film (porous film) of Example 7 was obtained. The thickness of the high porosity layer A was 4 μm and the porosity thereof was 55%.

### Example 8

A micro porous film was used as a base material, and the micro porous film was formed of a 5 μm thick single PP layer produced in the same manner as in Example 2 except that the film thickness of the PP web was changed. A high porosity layer B (organic particle layer) was formed on only one surface of the micro porous film in the same manner as in Example 5; and thereby,a separator film (porous film) of Example 8 was obtained. The thickness of the high porosity layer B was 2 μm and the porosity thereof was 55%.

The configurations of the separator films (porous films) produced in Examples 5 to 8 are summarized in Table 2.

TABLE 2

| | Base material | | | | | |
|---|---|---|---|---|---|---|
| | | | | | Example 7 | Example 8 |
| | Example 1 | Example 2 | Example 5 | Example 6 | 5 μm thick | 5 μm thick |
| | Example 1 | Example 2 | Example 1 | Example 2 | PP | PP |
| Configuration | Only base | Only base | Both sides | Both sides | Single side | Single side |
| | material | material | coating | coating | coating | coating |
| | Base | Base | High | High | High | High |
| | material | material | porosity | porosity | porosity | porosity |
| | | | layer A | layer A | layer A | layer B |
| | | | Base | Base | Base | Base |
| | | | material | material | material | material |
| | | | High | High | | |
| | | | porosity | porosity | | |
| | | | layer B | layer B | | |

### Example 9

A laminated battery was produced in the same manner as in Example 1 except that the separator film of Example 5 was used as a separator and the high porosity layer B (organic particle layer) was disposed in contact with the negative electrode surface, and a DC-R test was conducted. The results and the layer configuration between the positive electrode and the negative electrode in the device are shown in Table 3.

### Example 10

A laminated battery was produced in the same manner as in Example 1 except that the separator film of Example 5 was used as a separator and the high porosity layer A (inorganic particle layer) was disposed in contact with the negative electrode surface, and a DC-R test was conducted. The results and the layer configuration between the positive electrode and the negative electrode in the device are shown in Table 3.

### Example 11

A laminated battery was produced in the same manner as in Example 1 except that the separator film of Example 6 was used as a separator and the high porosity layer B (organic particle layer) was disposed in contact with the negative electrode surface, and a DC-R test was conducted. The results and the layer configuration between the positive electrode and the negative electrode in the device are shown in Table 3.

### Example 12

A laminated battery was produced in the same manner as in Example 1 except that the separator film of Example 6 was used as a separator and the high porosity layer A (inorganic particle layer) was disposed in contact with the negative electrode surface, and a DC-R test was conducted. The results and the layer configuration between the positive electrode and the negative electrode in the device are shown in Table 3.

### Example 13

A laminated battery was produced in the same manner as in Example 1 except that the respective separator films of Examples 7 and 8 were laminated to be used as a separator and the base material (micro porous film) of Example 8, the high porosity layer B (organic particle layer) of Example 8, the base material (micro porous film) of Example 7, and the high porosity layer A (inorganic particle layer) of Example 7 were disposed in this order from the negative electrode surface, and a DC-R test was conducted. The results and the layer configuration between the positive electrode and the negative electrode in the device are shown in Table 3.

### Example 14

A laminated battery was produced in the same manner as in Example 1 except that the respective separator films of Examples 7 and 8 were laminated to be used as a separator and the high porosity layer B (organic particle layer) of Example 8, the base material (micro porous film) of Example 8, the high porosity layer A (inorganic particle layer) of Example 7, and the base material (micro porous film) of Example 7 were disposed in this order from the negative electrode surface, and a DC-R test was conducted. The results and the layer configuration between the positive electrode and the negative electrode in the device are shown in Table 3.

### Example 15

A laminated battery was produced in the same manner as in Example 1 except that the respective separator films of Examples 4 and 7 were laminated to be used as a separator and the base material (micro porous film) of Example 4, the high porosity layer A (inorganic particle layer) of Example 7, and the base material (micro porous film) of Example 7 were disposed in this order from the negative electrode surface, and a DC-R test was conducted. The results and the layer configuration between the positive electrode and the negative electrode in the device are shown in Table 3.

### Example 16

A laminated battery was produced in the same manner as in Example 1 except that the respective separator films of Examples 4 and 8 were laminated to be used as a separator and the base material (micro porous film) of Example 4, the high porosity layer B (organic particle layer) of Example 8, and the base material (micro porous film) of Example 8 were disposed in this order from the negative electrode surface, and a DC-R test was conducted. The results and the layer configuration between the positive electrode and the negative electrode in the device are shown in Table 3.

### Example 17

A laminated battery was produced in the same manner as in Example 1 except that two sheets of the separator film of Example 7 were laminated to be used as a separator and the base material (micro porous film) of Example 7, the high porosity layer A (inorganic particle layer) of Example 7, the base material (micro porous film) of Example 7, and the high porosity layer A (inorganic particle layer) of Example 7 were disposed in this order from the negative electrode surface, and a DC-R test was conducted. The results and the layer configuration between the positive electrode and the negative electrode in the device are shown in Table 3.

### Example 18

A laminated battery was produced in the same manner as in Example 1 except that the respective separator films of Examples 7 and 8 were laminated to be used as a separator and the base material (micro porous film) of Example 7, the high porosity layer A (inorganic particle layer) of Example 7, the base material (micro porous film) of Example 8, and the high porosity layer B (organic particle layer) of Example 8 were disposed in this order from the negative electrode surface, and a DC-R test was conducted. The results and the layer configuration between the positive electrode and the negative electrode in the device are shown in Table 3.

Table 3 also shows the results of the DC-R tests of the laminated batteries in which the micro porous films of Examples 1 and 2 were used as the separators.

TABLE 3

| | Negative | | | Positive | |
|---|---|---|---|---|---|
| | electrode | | | electrode | DC-R |
| | surface | ← Disposition of separator → | | surface | ohm |
| Example 9 | Example 5 | | | | 0.65 |
| | High porosity | PP/PE/PP | | High porosity | |
| | layer B | | | layer A | |
| | (organic | | | (inorganic | |
| | particle layer) | | | particle layer) | |
| Example 10 | Example 5 | | | | 0.62 |
| | High porosity | PP/PE/PP | | High porosity | |
| | layer A | | | layer B | |
| | (inorganic | | | (organic | |
| | particle layer) | | | particle layer) | |
| Example 11 | Example 6 | | | | 0.61 |
| | High porosity | PP | | High porosity | |
| | layer B | | | layer A | |
| | (organic | | | (inorganic | |
| | particle layer) | | | particle layer) | |
| Example 12 | Example 6 | | | | 0.55 |
| | High porosity | PP | | High porosity | |
| | layer A | | | layer B | |
| | (inorganic | | | (organic | |
| | particle layer) | | | particle layer) | |
| Example 13 | Example 8 | | Example 7 | | 0.61 |
| | PP | High porosity | PP | High porosity | |
| | | layer B | | layer A | |
| | | (organic | | (inorganic | |
| | | particle layer) | | particle layer) | |
| Example 14 | Example 8 | | Example 7 | | 0.58 |
| | High porosity | PP | High porosity | PP | |
| | layer B | | layer A | | |
| | (organic | | (inorganic | | |
| | particle layer) | | particle layer) | | |
| Example 15 | Example 4 | | Example 7 | | 0.58 |
| | PP | | High porosity | PP | |
| | | | layer A | | |
| | | | (inorganic | | |
| | | | particle layer) | | |
| Example 16 | Example 4 | | Example 8 | | 0.54 |
| | PP | | High porosity | PP | |
| | | | layer B | | |
| | | | (organic | | |
| | | | particle layer) | | |
| Example 17 | Example 7 | | Example 7 | | 0.62 |
| | PP | High porosity | PP | High porosity | |
| | | layer A | | layer A | |
| | | (inorganic | | (inorganic | |
| | | particle layer) | | particle layer) | |
| Example 18 | Example 7 | | Example 8 | | 0.59 |
| | PP | High porosity | PP | High porosity | |
| | | layer A | | layer B | |
| | | (inorganic | | (organic | |
| | | particle layer) | | particle layer) | |

| | | |
|---|---|---|
| Example 1 | Example 1 | 0.61 |
| | PP/PE/PP | |
| Example 2 | Example 2 | 0.57 |
| | PP | |

As shown in Table 3, the laminated batteries in which the separators of Examples 9 to 18 were used had sufficiently low resistance.

1. A porous film comprising[[:]] a micro porous film in which a fibril diameter arranged in a direction perpendicular to an MD direction is 50 nm or more and 500 nm or less, a pore diameter is 50 nm or more and 200 nm or less, and a surface opening ratio is 5% or more and 40% or less.

2. The porous film according to claim 1, wherein the micro porous film comprises either one or both of a polyethylene resin and a polypropylene resin.

3. The porous film according to claim 1, wherein a compressive elastic modulus of the micro porous film in a film thickness direction is 95 MPa or more and 150 MPa or less.

4. The porous film according to claim 1, wherein the micro porous film has a film thickness of 7 μm or more and 40 μm or less and an air permeability of 80 sec/100 cc or more and 800 sec/100 cc or less.

5. The porous film according to claim 1, further comprising[[:]] a high porosity layer which is provided on one surface or both surfaces of the micro porous film and contains an organic binder.

6. The porous film according to claim 5, wherein the organic binder is one type or a mixture of two or more types selected from the group consisting of an acrylic resin, styrene butadiene rubber, a polyolefin-based resin, polytetrafluoroethylene, polyvinylidene fluoride, polyacrylonitrile, polymethyl methacrylate, and polyacrylic acid.

7. The porous film according to claim 5 or 6, wherein the high porosity layer contains organic particles which consist of one type or a mixture of two or more types selected from the group consisting of a polyethylene-based resin, a polypropylene-based resin, an acrylic resin, and a polystyrene-based resin, and the organic particles have a spherical shape, an elliptical shape, or a flat shape, and have a mode particle diameter of 0.1 μm or more and 5.0 μm or less.

8. The porous film according to claim 5, wherein the high porosity layer contains inorganic particles which consist of one type or a mixture of two or more types selected from the group consisting of alumina, alumina hydrate, zirconia, magnesia, aluminum hydroxide, magnesium hydroxide, magnesium carbonate, boehmite, and silica.

9. A power-storage device comprising:
a positive electrode;
a negative electrode;
a separator interposed between the positive electrode and the negative electrode; and
a non-aqueous electrolytic solution with which the separator is impregnated, wherein the separator comprises the porous film according to claim 1.

10. A power-storage device comprising:
a positive electrode;
a negative electrode;
a separator interposed between the positive electrode and the negative electrode; and
a non-aqueous electrolytic solution with which the separator is impregnated,
wherein the separator comprises the porous film according to claim 5, and
the high porosity layer of the porous film is disposed in contact with a surface of the negative electrode.

11. The power-storage device according to claim 9,
wherein the separator comprises: a first porous film which is the porous film including the micro porous film; and a second porous film which is the porous film including the high porosity layer on one surface of the micro porous film, and
the high porosity layer of the second porous film is disposed in contact with the first porous film.
